(19) United States
(12) Patent Application Publication
(10) Pub. No.: US 2017/0037679 A1
(43) Pub. Date: Feb. 9, 2017

(54) ROLL BLIND CAPABLE OF ADJUSTING LIGHT ADMISSION

(71) Applicant: Eun Ro AN, Seongnam-si (KR)

(72) Inventor: Eun Ro AN, Seongnam-si (KR)

(21) Appl. No.: 15/110,649

(22) PCT Filed: Jan. 28, 2015
(86) PCT No.: PCT/KR2015/000869

§ 371 Date: Oct. 21, 2016

(30) Foreign Application Priority Data
Feb. 18, 2014 (KR) 1020140018184
May 29, 2014 (KR) 1020140064783

(51) Int. Cl. E06B 9/264; E06B 9/56; E06B 9/66; E06B 9/34; E06B 9/68

(52) U.S. Cl. CPC E06B 9/264; E06B 9/34; E06B 9/68; E06B 9/66; E06B 9/56; E06B 2009/2435

(57) ABSTRACT

The present invention relates to a roll blind comprising a rolling device provided at a lower end of a vertically suspending curtain sheet to roll the curtain sheet, and a shaft rolling and releasing a traction rod vertically extending from a head rail at an upper end to move up and down the rolling device at a lower end, the roll blind further comprising a driving gear rotating together with the shaft around a fixed shaft and having a cylindrical drum extending in an axial direction; a friction spring tightly wound around the drum and having a protruding end protruding in a radial direction; and a tube wheel rotating together with the friction wheel via the protruding end, wherein the curtain sheet comprises a front sheet and a rear sheet disposed front and rear with a predetermined horizontal interval therebetween, and a number of blind sheets connecting the front sheet and the rear sheet, the rear sheet is relatively fixed to the head rail at its upper end to be fixed in the horizontal direction, the front sheet has its upper end to move in a rotational direction according to a rotation of the tube wheel so that the horizontal and the vertical interval between the front sheet and the rear sheet can be adjusted simultaneously, and an inclination angle of the blind sheets is adjusted according to the adjustment of the horizontal and the vertical intervals between the front sheet and the rear sheet, so that light admission can be adjusted.

### TECHNICAL FIELD

The present invention relates to a roll blind or a roll screen installed inside of a window, and more particularly to a roll blind having a rolling device provided at a lower end of a vertically hanging curtain sheet.

### BACKGROUND ART

According to a conventional roll blind, the curtain sheet extends axially while it is being rolled if its thickness and elasticity are not even. Also, only a thin curtain sheet can be used because a thick curtain sheet makes a roll of a big volume. Moreover, as it is hard to disassemble and re-assemble an installed curtain sheet, the whole roll blind has to be replaced with a new one in a predetermined period of use.

To solve such problems, the applicant has introduced a rolling device for roll blind using roman shade rolling device through a Korean Patent No. 10-0905665 (registration date: Jun. 24, 2009) where the curtain sheet is rolled and unrolled from its lower end.

The present invention is an improvement of the above Korean Patent No. 10-0905665 to enable adjustment of light admission.

### DISCLOSURE

### Technical Problem

Accordingly, it is an object of the present invention to provide a roll blind having a rolling device provided at a lower end of a vertically hanging curtain sheet, especially a roll blind improved to adjust light admission.

### Technical Solution

In order to accomplish the above object, the present invention provides a roll blind comprising a rolling device provided at a lower end of a vertically suspending curtain sheet to roll the curtain sheet, and a shaft rolling and releasing a traction rod vertically extending from a head rail at an upper end to move up and down the rolling device at a lower end, the roll blind further comprising: a driving gear rotating together with the shaft around a fixed shaft and having a cylindrical drum extending in an axial direction; a friction spring tightly wound around the drum and having a protruding end protruding in a radial direction; and a tube wheel rotating together with the friction wheel via the protruding end, wherein the curtain sheet comprises a front sheet and a rear sheet disposed front and rear with a predetermined horizontal interval therebetween, and a number of blind sheets connecting the front sheet and the rear sheet and disposed in a vertical direction with a predetemined interval therebetween, one of the front sheet and the rear sheet is relatively fixed to the head rail at its upper end to be fixed in the horizontal direction, the other of the front sheet and the rear sheet has its upper end to move in a rotational direction according to a rotation of the tube wheel so that the horizontal and the vertical interval between the front sheet and the rear sheet can be adjusted simultaneously, and an inclination angle of the blind sheets is adjusted according to the adjustment of the horizontal and the vertical intervals between the front sheet and the rear sheet.

According to an aspect of the present invention, the tube wheel is inserted around the drum and a inserting groove is formed on an inner surface of the tube wheel to insert the protruding end therein.

According to an aspect of the present invention, the roll blind further comprising a clutch gear rotated by an outer force via a driving cord to rotate the shaft so that the traction cord can be wound or released, wherein the driving gear mates with the clutch gear.

According to an aspect of the present invention, the roll blind further comprising a clutch end cap coupled to one end side of the head rail to rotatably support the driving gear and the clutch gear respectively.

According to an aspect of the present invention, the protruding end is provided as a pair to be separate in a circular direction with a predetermined angle therebetween, the tube wheel is inserted around the drum and has on an inner surface a protruding arc disposed between a plurality of the protruding ends to be pressed in the circular direction to rotate by a plurality of the protruding ends when a plurality of the protruding ends is relatively pressed by the protruding arc in a direction where the friction spring is tightened further, the fixed shaft has a stopper protruding at a side and disposed between a pair of the protruding ends at the opposite side of the protruding arc so that, when the stopper contacts a pair of the protruding ends due to the rotation of the driving gear, it presses the friction spring in a direction where the friction spring is released and stops the rotation of the friction spring.

According to an aspect of the present invention, the roll blind further comprising a stopper wheel rotatably coupled to the fixed shaft and having at a side a guide arc which is disposed between a pair of the protruding ends at the opposite side of the protruding arc and also between the stopper and one of the protruding ends, wherein the stopper contacts and presses a pair of the protruding ends via the guide arc of the stopper wheel.

According to an aspect of the present invention, the roll blind further comprising: a clutch gear rotated by an outer force via a driving cord to rotate the shaft so that the traction cord can be wound or released; and a transmission gear drum rotatably coupled to the clutch gear to have the same rotational axis, rotated together with the clutch gear via a second friction spring and having a transmission gear at a side in an axial direction, wherein the driving gear mates with the transmission gear.

According to an aspect of the present invention, the roll blind further comprising a clutch end cap coupled to an end side of the head rail and having a fixed drum to receive a shaft center of the clutch gear therein to rotatably support the shaft center, wherein the second friction spring is tightly wound around the fixed drum and has a pair of second protruding ends protruding in a radial direction and separated therebetween in the circular direction with a predetermined angle therebetween, and the transmission gear drum is inserted around the fixed drum and has at an inner surface a second protruding arc disposed between a pair of the second protruding ends, so that a pair of the second protruding ends relatively presses the second friction spring due to the second protruding arc in a direction where the second friction spring is tightened further.

According to an aspect of the present invention, the roll blind further comprising a transmission wheel rotatably coupled to the fixed drum to rotate integrally with the shaft center of the clutch gear and having at a side a transmission arc to disposed between a pair of the second protruding ends at the opposite side of the second protruding arc, wherein the transmission arc contacts a pair of the second protruding ends due to the rotation of the clutch gear so that it presses and rotates the second friction spring in a direction where the second friction spring is released.

According to an aspect of the present invention, the roll blind further comprising an electric motor driving the shaft to rotate, wherein the driving gear is rotated together with the shaft by the electric motor.

According to an aspect of the present invention, the roll blind further comprising a blind adjusting tube receiving the tube wheel therein and rotating together with the tube wheel, wherein an upper end of the other of the front sheet and the rear sheet is coupled to the blind adjusting tube so that it is moved in the circular direction around a center of the blind adjusting tube.

According to an aspect of the present invention, the blind adjusting tube has at a side an opening extending in an axial direction and has a wall part at an inner side of the opening to extend in the circular direction to a predetermined angle, the upper end of the other of the front sheet and the rear sheet is inserted and supported within the wall part through the opening, and the tube wheel has a receiving part formed to be depressed in the circular direction along the predetermined angle to receive the wall part, so that it rotates integrally with the tube wheel via the wall part.

### Advantageous Effects

According to the roll blind of the present invention as described above, the roll blind has a rolling device at a lower end of a curtain sheet to roll it, and especially the roll blind has a driving gear, a friction spring and a tube wheel in a head rail at an upper end side and the curtain sheet is provided with a front sheet, a rear sheet and blind sheets. Therefore, inclination angle of the blind sheets can be adjusted by adjusting distance between the front and the rear sheets so that the light admission can be adjusted.

### DESCRIPTION OF DRAWINGS

FIG. 1 and FIG. 2 are front and rear perspective views of a roll blind according to a first exemplary embodiment of the present invention;

FIG. 3 is an exploded view of a principal part of the roll blind in FIG. 1;

FIG. 4 and FIG. 5 are front and rear exploded views of some components of the principal part of FIG. 3;

FIG. 6 is a partial sectional view of combination of the components of FIG. 4;

FIG. 7 to FIG. 8b are simplified partial sectional views for describing operation of the roll blind of FIG. 1;

FIG. 9 and FIG. 10 are front and rear exploded views of a principal components of a roll blind according to a second exemplary embodiment of the present invention;

FIG. 11 is a sectional view of combination of the components of FIG. 9;

FIG. 12 and FIG. 13 are sectional views for describing operation of the components of FIG. 11; and

FIG. 14 is a sectional view of combination of principal components of a roll blind according to a third exemplary embodiment of the present invention.

### BEST MODE

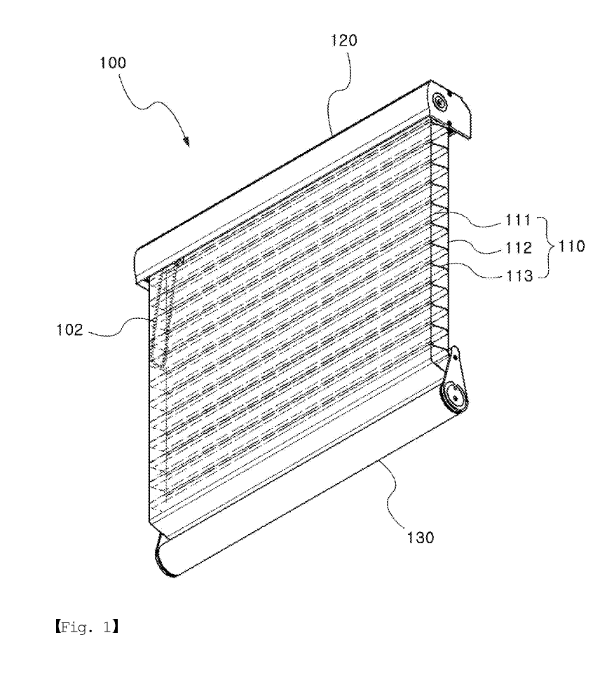

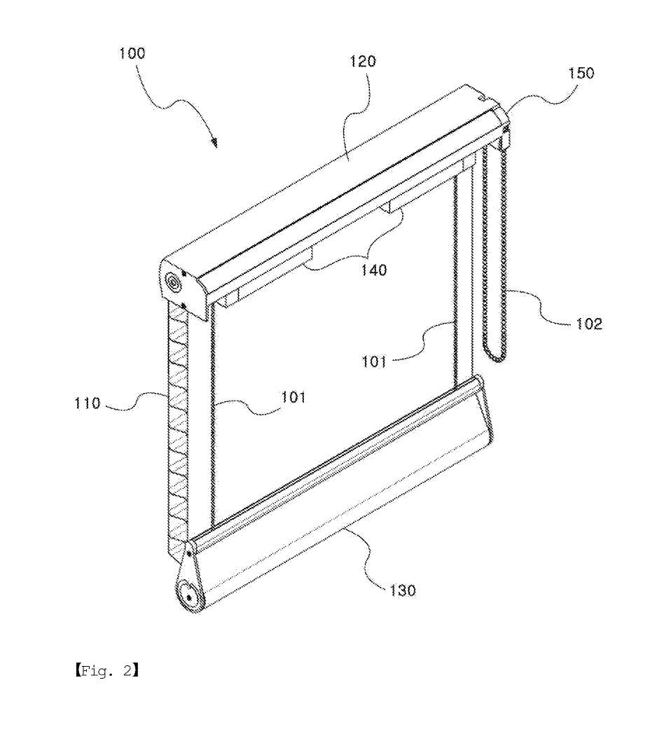

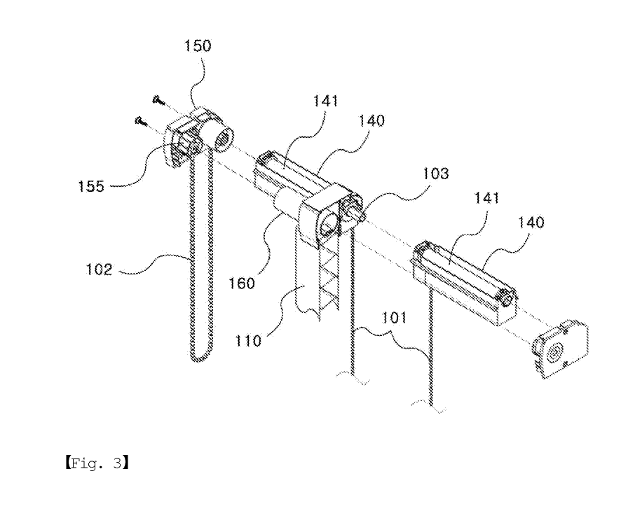

As shown in FIG. 1 and FIG. 2, a roll blind 100 according to a first exemplary embodiment of the present invention comprises a curtain sheet 110 having a front sheet 111, a rear sheet 112 and a number of blind sheets 113 which are disposed vertically with a predetermined interval therebetween to connect the front sheet 111 and the rear sheet 112. The curtain sheet 110 is fixed to a head rail 120 at its upper end so that it can be vertically suspended. A rolling device 130 is provided at a lower end of the curtain sheet 110 for rolling it.

The rolling device 130 moves up and down if a traction cord 101 which suspends and supports the rolling device 130 is wound and released by a roll driving box 140 provided at the head rail 120.

As the rolling device 130 moves up and down, a lower end of the curtain 110 is wound into the rolling device 130 and released out of the rolling device 130.

Operation of the roll driving box 140 for elevating the rolling device 130 is made by a driving cord 102 provided at a side of the head rail 120.

As the rolling device 130 is the same or similar to that shown in the above Korean Patent No. 10-0905665, detail description of the rolling device 130 is omitted here.

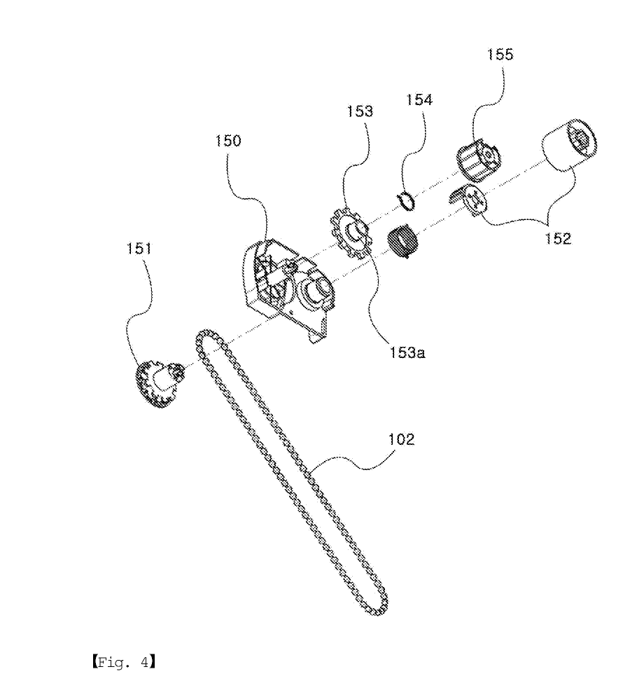

As shown in FIG. 3, the roll driving box 140 has a cone 141 integrally rotating with a shaft 103 which is driven to rotate by the operation of the driving cord 102. An upper end of the traction cord 101 is coupled to the cone 141 so that it is wound around or released from the rotating cone 141.

As shown in FIG. 2 and FIG. 3, the roll blind 100 according to the first exemplary embodiment of the present invention has a function of adjusting light admission of the curtain sheet 110 with the operation of the driving cord 102, that is used for the elevation of the rolling device 130, through some components which are received and supported in a clutch end cap 150 that is coupled to one longitudinal end side of the head rail 120.

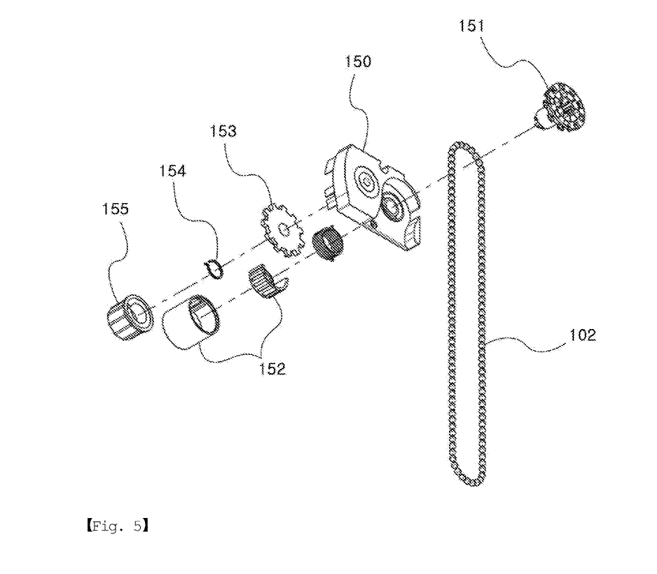

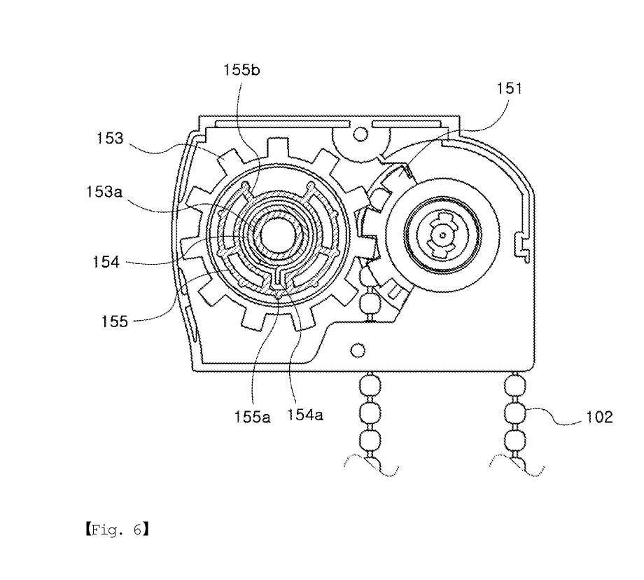

To describe in more detail, as shown in FIG. 4 and FIG. 5, a clutch gear 151 is rotatably supported in the clutch end cap 150 to be driven to rotate by the operation of the driving cord 102. The clutch gear 151 rotates a shaft 103 (refer to FIG. 3) via transmission components 152.

Especially, the clutch end cap 150 rotatably supports a driving gear 153 which is disposed parallel with the clutch gear 151 to mate and rotate therebetween. Accordingly, the driving gear 153 rotates together with the shaft 103 (refer to FIG. 3) via the clutch gear 151 by the operation of the driving cord 102, which means that the driving gear 153 can be operated by the driving cord 102 which is for elevating the rolling device 130.

The driving gear 153 has a cylindrical drum 153a extending in the axial direction. A friction spring 154 is tightly wound around the drum 153a.

Then, a tube wheel 155 is inserted over the drum 153a which is tighten by the friction spring 154.

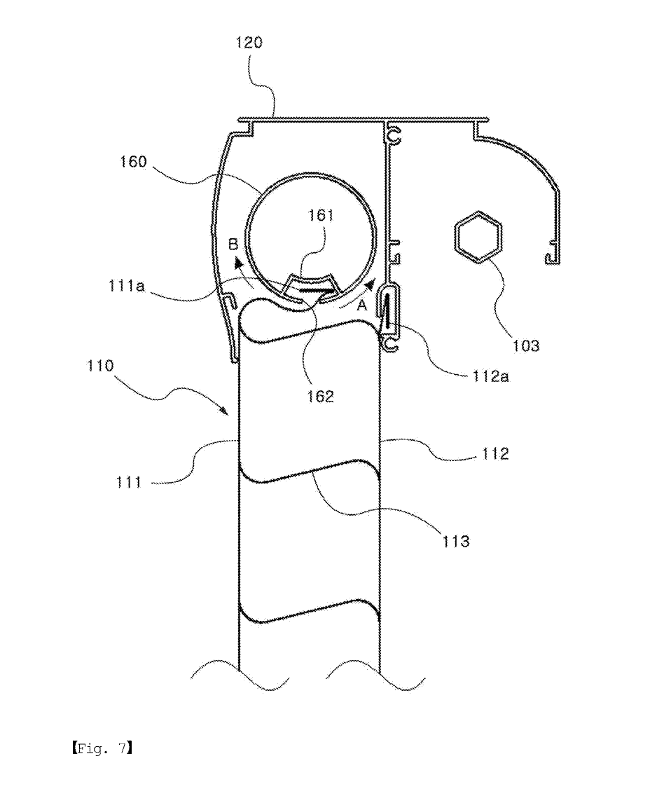

In this case, as shown in FIG. 6, the tube wheel 155 is foLmed with an insert groove 155a at an inner surface so that a protruding end 154a of the friction spring 154 is inserted in the insert groove 155a.

Accordingly, the tube wheel 155 rotates with the driving gear 153 via the friction spring 154. However, if the tube wheel 155 receives an excessive load, that is, if it receives a load exceeding the tightening force exerted by the friction spring 154 on the drum 153a, the friction spring 154 and the tube wheel 155 do not rotate when the driving gear 153 rotates.

The tube wheel 155 is inserted into a blind adjusting tube 160 of FIG. 7 (refer to FIG. 3). In this case, the tube wheel 155 has a receiving part 155b which is formed to be depressed in a circular direction along a predetermined angle as shown in FIG. 6. Correspondingly, the blind adjusting tube 160 has at its inner surface a wall part 161 which is formed protruded in the circular direction along said predetermined angle. Therefore, the wall part 161 is received and supported in the receiving part 155b of the tube wheel 155. Accordingly, the tube wheel 155 and the blind adjusting tube 160 rotate integrally therebetween.

AS shown in FIG. 7, the blind adjusting tube 160 has an opening 162 at its outer surface to correspond to the wall part 161. The upper end 111a of the front sheet 111 of the curtain sheet 110 is inserted and supported within the wall part 161 through the opening 162.

On the other hand, the upper end 112a of the rear sheet 112 of the curtain sheet 110 is inserted into the head rail 120 and supported therein.

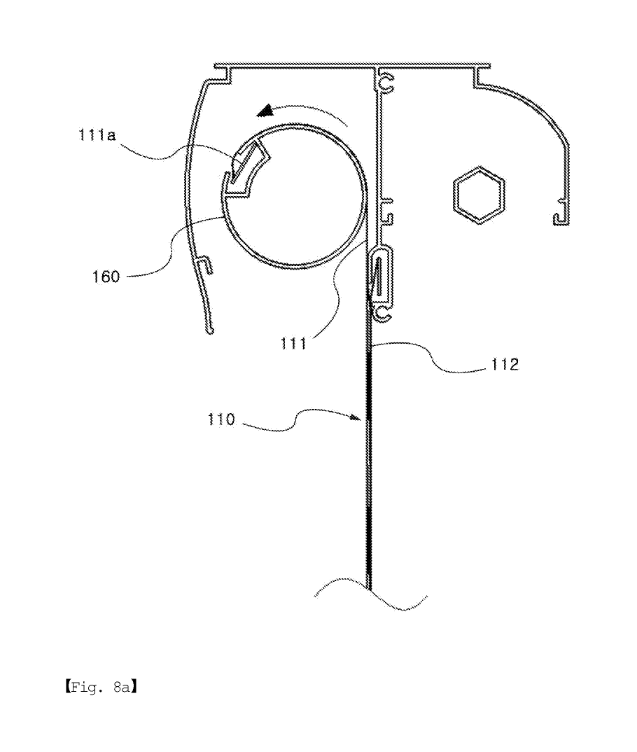

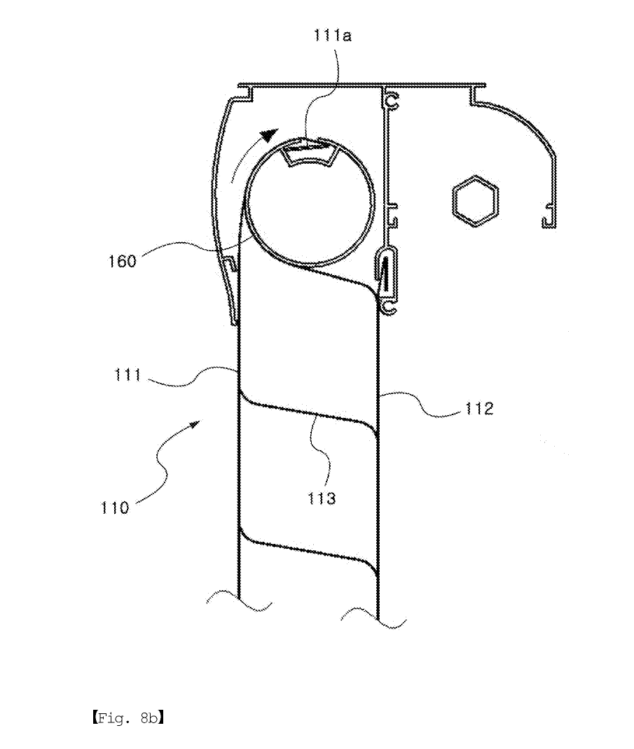

Therefore, If the blind adjusting tube 160 rotates counterclockwise A, the upper end 111a of the front sheet rotates accordingly in the circular direction. At last, as shown in FIG. 8a, the front sheet 111 contacts close to the rear sheet 112.

In this case, as the front sheet 111 moves up and backwardly (in the right direction in FIGS. 7 and 8a) at the same time, the blind sheets 113 connecting the front sheet 111 and the rear sheet 112 rotate clockwise with respect to the rear sheet 112 and overlaps on the surface of the rear sheet 112. In this way, the curtain sheet 110 can make complete veiling between front and rear (left and right in FIG. 8a).

Therefore, inclination angle of the blind sheets 113 can be adjusted according to the rotation angle of the blind adjusting tube 160, so that the veiling level of the curtain sheet 110 can be adjusted.

In the complete veiling state of the curtain sheet as shown in FIG. 8a, the blind adjusting tube 160 receives comparably much load from the curtain sheet 110. In this state, even if the driving gear 153 of FIG. 6 rotates further counterclockwise, the friction spring 154 does not rotate because of said load transmitted via the tube wheel 155 and the drum 153a makes an idle rotation. At last, a further rotation of the clutch gear 151 after the state of FIG. 8a makes the rolling device 130 move up or down where the curtain sheet 110 is wound into or released from the rolling device 130 at its lower end.

However, if the blind adjusting tube 160 rotates clockwise B in FIG. 7, the upper end 111a of the front sheet rotates accordingly in the circular direction. Then, at last, in the tightened state as shown in FIG. 8b, the blind adjusting tube 160 receives a comparably much load as described above. Therefore, even if the driving gear 153 of FIG. 6 rotates further clockwise, the friction spring 154 does not rotate because of said load transmitted via the tube wheel 155 and the drum 153a makes an idle rotation.

At last, a further rotation of the clutch gear 151 after the state of FIG. 8b makes the rolling device 130 move down or up where the curtain sheet 110 is released from or wound into the rolling device 130 at its lower end.

In conclusion, at any vertical position of the rolling device 130, the blind sheets 113 can be adjusted to be inclined to any angle between FIG. 8a and FIG. 8b.

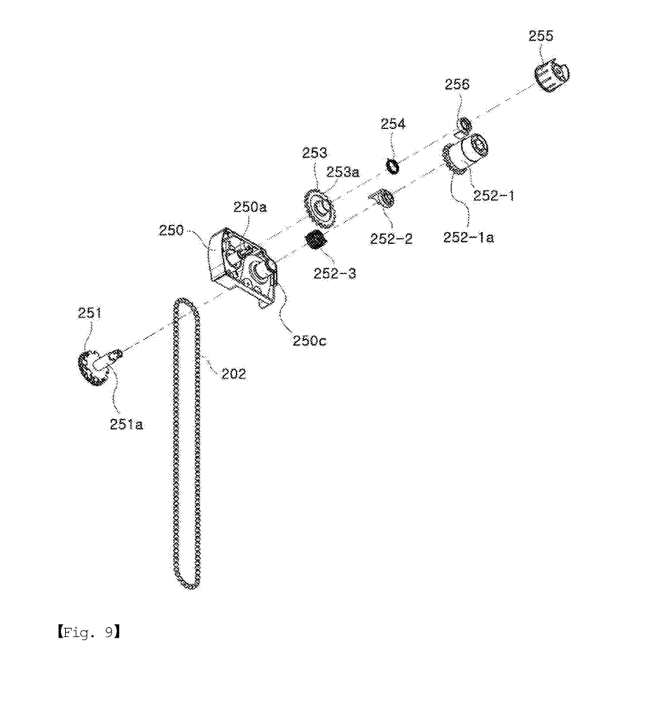

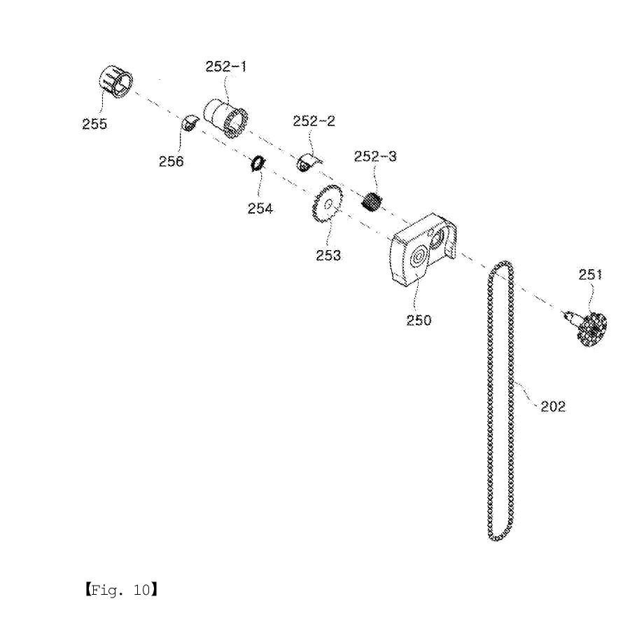

As shown in FIG. 9 and FIG. 10, a roll blind according to a second exemplary embodiment of the present invention comprises a clutch end cap 250 where a clutch gear 251 driven by the operation of the driving cord 102 is rotatably supported.

The clutch end cap 250 has a fixed shaft 250a to be inserted into a driving gear 253 to rotatably support. A friction spring 254 is tightly wound around a cylindrical drum 253a of the driving gear 253. A stopper wheel 256 and a tube wheel 255 rotate together with the driving gear 253 via the friction spring 254.

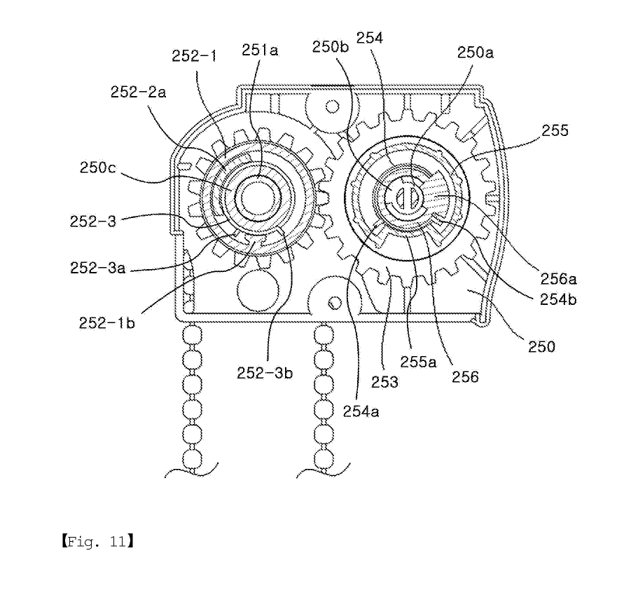

To describe in more detail, as shown in FIG. 11, the friction spring 254 is provided with a pair of protruding ends 254a, 254b which are foLmed to be separated therebetween with a predetermined angle in a circular direction.

Correspondingly, the tube wheel 255 has at its inner surface a protruding arc 255a extending in a circular direction to be disposed between a pair of the protruding ends 254a, 254b.

Therefore, the friction spring 254 which rotates together with the driving gear 253 presses the protruding arc 255a in the circular direction via the protruding ends 254a, 254b to rotate the tube wheel 255.

In this case, the protruding arc 255a which is pressed in the circular direction relatively presses the protruding ends 254a, 254b in the opposite circular direction, that is, in the direction where the friction spring 254 is tightened further, so that the friction spring 254 does not make an idle rotation on the driving gear 253 but always rotates integrally.

Therefore, as long as the rotation of the driving gear 253 is prevented, the friction spring 254 is tightened further if the tube wheel 255 is about to rotate due to outer force or weight of the curtain sheet so that self-rotation of the tube wheel 255 can be prevented.

The fixed shaft 250a which rotatably supports the driving gear 253 has a stopper 250b at a lateral side to contact and support the protruding ends 254a, 254b of the friction spring 254 which rotates around the fixed shaft 250a via the stopper wheel 256 that is also rotatably coupled to the fixed shaft 250a.

To this end, the stopper wheel 256 has at one side a guide arc 256a to be disposed between the protruding ends 254a, 254b at the opposite side of the protruding arc 255a. Also, the guide arc 256a is disposed between one protruding end 254b and the stopper 250b as shown in FIG. 11.

According to such a combination, if the driving gear 253 rotates clockwise in FIG. 11, the friction spring 254 rotates integrally first and then one protruding end 254b contacts and presses the protruding arc 255a clockwise to rotate the tube wheel 255.

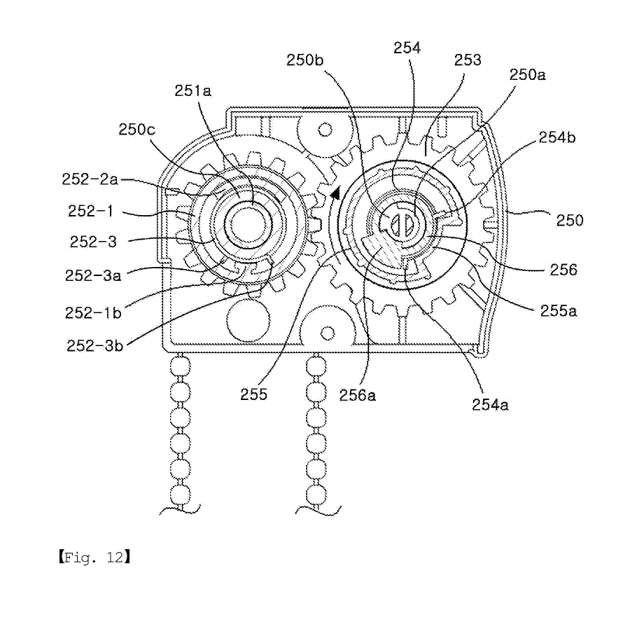

Then, the other protruding end 254a rotates clockwise to contact and press the guide arc 256a and pushes it clockwise to rotate together, and the rotating guide arc 256a contacts the stopper 250b and the rotation is stopped at last. This state is as shown in FIG. 12.

The stopper 250b as well as the guide arc 256a is disposed between a pair of the protruding ends 254a, 254b at the opposite side of the protruding arc 255a. Therefore, even if the driving gear 253 rotates further clockwise in FIG. 12, one protruding end 254a is relatively pressed counterclockwise to make the friction spring 254 released so that the friction spring 254 stops and does not rotate any more. Of course, unlike such a friction spring 254, the driving gear 253 continues to rotate clockwise.

On the other hand, if the driving gear 253 rotates counterclockwise in FIG. 11, the friction spring 254 rotates integrally first and then one protruding end 254a contacts and presses the protruding arc 255a counterclockwise to rotate the tube wheel 255.

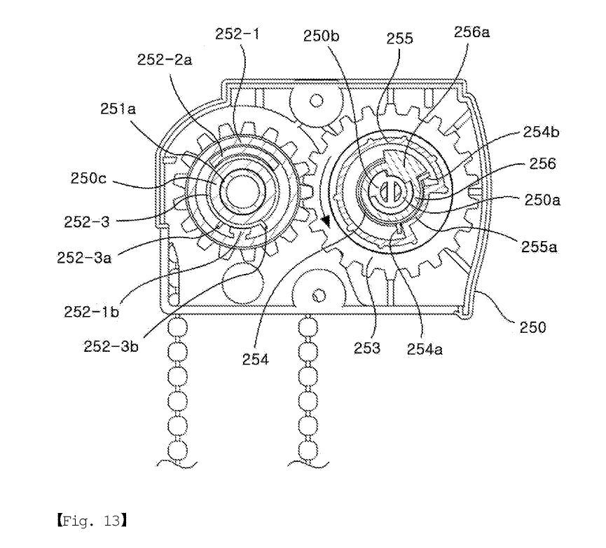

Then, the other protruding end 254b also rotates counterclockwise to contact and press the guide arc 256a and pushes it counterclockwise to rotate together. The rotating guide arc 256a contacts the stopper 250b at last so that the rotation is stopped. Such a stat is as shown in FIG. 13.

Even if the driving gear 253 further rotates counterclockwise, the stopper 250b relatively presses one protruding end 254b clockwise to release the friction spring 254. Therefore, unlike the driving gear 253, the friction spring 254 stops and does not further rotate.

Within the range of rotation of the tube wheel 255 between the states of FIG. 12 and FIG. 13, one of the front sheet and the rear sheet can be lifted and the inclination angle of the blind sheets can be adjusted.

Especially, the range of the rotation of the tube wheel 255 can be significantly expanded by the disposition of the stopper wheel 256 in comparison with the case where there is not such a stopper wheel 256. In this embodiment, the rotational angle of the tube wheel 255 between FIG. 12 and FIG. 13 is about 360 degrees.

As the rotational angle of the tube wheel 255 increases, the vertical difference between the front sheet and the rear sheet also increases. Consequently, vertical width of the blind sheet and vertical interval between blind sheets can be increased.

In this embodiment, the driving gear 253 does not directly mate with the clutch gear 251 but mates with a transmission gear 252-1a formed at an axial end side of a transmission gear drum 252-1 which rotates together with the clutch gear 251.

The transmission gear drum 252-1 rotates together with the clutch gear 251 via a second friction spring 252-3. To describe in more detail, a shaft center 251a of the clutch gear 251 is received within a fixed drum 250c of the clutch end cap 250 to be rotatably supported. The second friction spring 252-3 is tightly wound around the fixed drum 250c.

The transmission gear drum 252-1 is inserted around a fixed drum 250c to be rotatably supported with the same rotational center. A second protruding arc 252-1b is formed from an inner surface of the transmission gear drum 252-1 to protrude radially toward the second friction spring 252-3 between a pair of second protruding ends 252-3a, 252-3b which are separate therebetween to a predetermined angle.

Especially, the second protruding arc 252-1b presses a pair of the second protruding ends 252-3a, 252-3b further tightly during its relative rotation with the second friction spring 252-3. Therefore, not the rotation due to the clutch gear 251 but the rotation due to the driving gear 253 is prevented by the second friction spring 252-3.

In this case, the transmission of the rotational force of the clutch gear 251 to the transmission gear drum 252-1 is accomplished by a transmission wheel 252-2.

The transmission wheel 252-2 is integrally coupled to the shaft center 251a of the clutch gear 251 at an axial end of the fixed drum 250c to be rotable with respect to the fixed drum 250c.

The transmission wheel 252-2 has at a side a transmission arc 252-2a to be disposed between a pair of the second protruding ends 252-3a, 252-3b at the opposite side of the second protruding arc 252-1b.

Therefore, the transmission arc 252-2a rotates integrally with the clutch gear 251 so that it contacts and presses one of the second protruding ends 252-3a or 252-3b to release and rotate the second friction spring 252-3. With this, the second protruding arc 252-1b of the electric gear drum 252-1 is contacted and rotated.

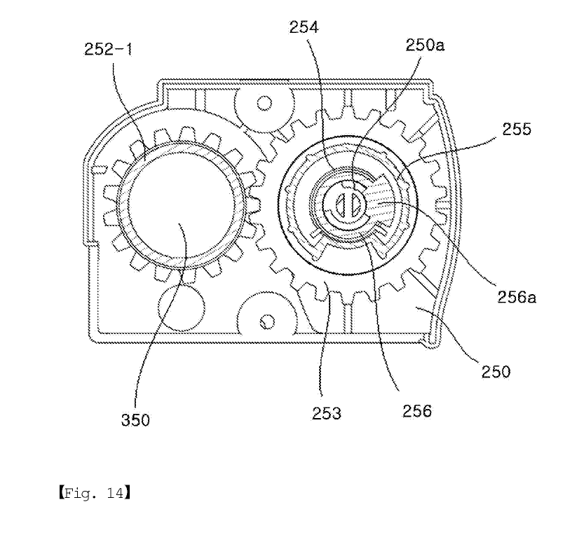

As shown in FIG. 14, a roll blind according to a third exemplary embodiment of the present invention has the transmission gear drum 252-1 which is directly driven by an electric motor 350. In this case, the clutch gear 251, driving cord 202 and etc. for manually operating the transmission gear drum 252-1 can be excluded.

Although the roll blinds have been disclosed, various modifications, additions and substitutions are possible, without departing from the scope and spirit of the invention.

Therefore, the above embodiments must be regarded as examples provided for description of the present invention, rather than to limit the present invention.

What is claimed is:

1. A roll blind comprising a rolling device provided at a lower end of a vertically suspending curtain sheet to roll the curtain sheet, and a shaft rolling and releasing a traction rod vertically extending from a head rail at an upper end to move up and down the rolling device at a lower end, the roll blind further comprising:
a driving gear rotating together with the shaft around a fixed shaft and having a cylindrical drum extending in an axial direction; a friction spring tightly wound around the drum and having a protruding end protruding in a radial direction; and a tube wheel rotating together with the friction wheel via the protruding end, wherein
the curtain sheet comprises a front sheet and a rear sheet disposed front and rear with a predetermined horizontal interval therebetween, and a number of blind sheets connecting the front sheet and the rear sheet and disposed in a vertical direction with a predetermined interval therebetween,
one of the front sheet and the rear sheet is relatively fixed to the head rail at its upper end to be fixed in the horizontal direction,
the other of the front sheet and the rear sheet has its upper end to move in a rotational direction according to a rotation of the tube wheel so that the horizontal and the vertical interval between the front sheet and the rear sheet can be adjusted simultaneously, and
an inclination angle of the blind sheets is adjusted according to the adjustment of the horizontal and the vertical intervals between the front sheet and the rear sheet.

2. The roll blind according to claim 1, wherein the tube wheel is inserted around the drum and a inserting groove is formed on an inner surface of the tube wheel to insert the protruding end therein.

3. The roll blind according to claim 1 further comprising a clutch gear rotated by an outer force via a driving cord to rotate the shaft so that the traction cord can be wound or released,
wherein the driving gear mates with the clutch gear.

4. The roll blind according to claim 3 further comprising a clutch end cap coupled to one end side of the head rail to rotatably support the driving gear and the clutch gear respectively.

5. The roll blind according to claim 1, wherein the protruding end is provided as a pair to be separate in a circular direciton with a predetermined angle therebetween,
the tube wheel is inserted around the drum and has on an inner surface a protruding arc disposed between a plurality of the protruding ends to be pressed in the circular direction to rotate by a plurality of the protruding ends when a plurality of the protruding ends is relatively pressed by the protruding arc in a direction where the friction spring is tightened further,
the fixed shaft has a stopper protruding at a side and disposed between a pair of the protruding ends at the opposite side of the protruding arc so that, when the stopper contacts a pair of the protruding ends due to the rotation of the driving gear, it presses the friction spring in a direction where the friction spring is released and stops the rotation of the friction spring.

6. The roll blind according to claim 5 further comprising a stopper wheel rotatably coupled to the fixed shaft and having at a side a guide arc which is disposed between a pair of the protruding ends at the opposite side of the protruding arc and also between the stopper and one of the protruding ends,
wherein the stopper contacts and presses a pair of the protruding ends via the guide arc of the stopper wheel.

7. The roll blind according to claim 1 further comprising:
a clutch gear rotated by an outer force via a driving cord to rotate the shaft so that the traction cord can be wound or released; and
a transmission gear drum rotatably coupled to the clutch gear to have the same rotatational axis, rotated together with the clutch gear via a second friction spring and having a transmission gear at a side in an axial direction,
wherein the driving gear mates with the transmission gear.

8. The roll blind according to claim 7 further comprising a clutch end cap coupled to an end side of the head rail and having a fixed drum to receive a shaft center of the clutch gear therein to rotatably support the shaft center,
wherein the second friction spring is tightly wound around the fixed drum and has a pair of second protruding ends protruding in a radial direciton and separated therebetween in the circular direction with a predetermined angle therebetween, and
the transmission gear drum is inserted around the fixed drum and has at an inner surface a second protruding arc disposed between a pair of the second protruding ends, so that a pair of the second protruding ends relatively presses the second friction spring due to the second protruding arc in a direction where the second friction spring is tightened further.

9. The roll blind according to claim 8 further comprising a transmission wheel rotatably coupled to the fixed drum to rotate integrally with the shaft center of the clutch gear and having at a side a transmission arc to disposed between a pair of the second protruding ends at the opposite side of the second protruding arc,
wherein the transmission arc contacts a pair of the second protruding ends due to the rotation of the clutch gear so that it presses and rotates the second friction spring in a direction where the second friction spring is released.

10. The roll blind according to claim 1 further comprising an electric motor driving the shaft to rotate,
wherein the driving gear is rotated together with the shaft by the electric motor.

11. The roll blind according to claim 1 further comprising a blind adjusting tube receiving the tube wheel therein and rotating together with the tube wheel,
wherein an upper end of the other of the front sheet and the rear sheet is coupled to the blind adjusting tube so that it is moved in the circular direction around a center of the blind adjusting tube.

12. The roll blind according to claim 11, wherein the blind adjusting tube has at a side an opening extending in an axial direction and has a wall part at an inner side of the opening to extend in the circular direction to a predetermined angle,
the upper end of the other of the front sheet and the rear sheet is inserted and supported within the wall part through the opening, and
the tube wheel has a receiving part formed to be depressed in the circular direction along the predetermined angle to receive the wall part, so that it rotates integrally with the tube wheel via the wall part.

13. The roll blind according to claim 2 further comprising a clutch gear rotated by an outer force via a driving cord to rotate the shaft so that the traction cord can be wound or released,
wherein the driving gear mates with the clutch gear.

14. The roll blind according to claim 13 further comprising a clutch end cap coupled to one end side of the head rail to rotatably support the driving gear and the clutch gear respectively.

15. The roll blind according to claim 5 further comprising:
a clutch gear rotated by an outer force via a driving cord to rotate the shaft so that the traction cord can be wound or released; and
a transmission gear drum rotatably coupled to the clutch gear to have the same rotational axis, rotated together with the clutch gear via a second friction spring and having a transmission gear at a side in an axial direction,
wherein the driving gear mates with the transmission gear.

16. The roll blind according to claim 15 further comprising a clutch end cap coupled to an end side of the head rail and having a fixed drum to receive a shaft center of the clutch gear therein to rotatably support the shaft center,
wherein the second friction spring is tightly wound around the fixed drum and has a pair of second protruding ends protruding in a radial direction and separated therebetween in the circular direction with a predetermined angle therebetween, and
the transmission gear drum is inserted around the fixed drum and has at an inner surface a second protruding arc disposed between a pair of the second protruding ends, so that a pair of the second protruding ends relatively presses the second friction spring due to the second protruding arc in a direction where the second friction spring is tightened further.

17. The roll blind according to claim 16 further comprising a transmission wheel rotatably coupled to the fixed drum to rotate integrally with the shaft center of the clutch gear and having at a side a transmission arc to disposed between a pair of the second protruding ends at the opposite side of the second protruding arc,
wherein the transmission arc contacts a pair of the second protruding ends due to the rotation of the clutch gear so that it presses and rotates the second friction spring in a direction where the second friction spring is released.
